(19) United States
(12) Patent Application Publication
(10) Pub. No.: US 2010/0070368 A1
(43) Pub. Date: Mar. 18, 2010

(54) REGISTERING ADVERTISEMENTS ON AN ELECTRONIC MAP

(75) Inventors: Jinwan Choi, Gyeonggi-do (KR); Kyungsung Shon, Gyeonggi-do (KR)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/233,412

(22) Filed: Sep. 18, 2008

(30) Foreign Application Priority Data
Sep. 11, 2008 (KR) 10-2008-89873

(51) Int. Cl. G06Q 30/00; G06F 17/30

(52) U.S. Cl. 705/14.58; 707/E17.044

(57) ABSTRACT

Various methods and apparatus are described relating to registration and display of advertisements for display on an electronic map.

### BACKGROUND OF THE INVENTION

The present invention generally relates to a method of registering advertisements on an electronic map, and more particularly to a method of registering advertisements on an electronic map by using advertisement registration reference information displayed on the electronic map.

With the development and widespread use of the Internet, advertising is an increasingly important part of the economic foundation of the Internet. Advertising using the Internet includes displaying advertisements on a specific location of an electronic map based on the Geographic Information System (GIS).

The GIS is a system that collects, stores, analyzes and processes geographical data for application to geographic-related fields (e.g., roads, traffics, telecommunication, gas, water pipes, water resources, forest resources, geological soils, etc.). An electronic map refers to a map that is provided by collecting and processing ground data regarding roads and facilities, and digitally transforming the data. An electronic map may be implemented by software configured to transform conventional paper maps into digital data. Alternatively, an electronic map may be created using digital information obtained from GPS receivers or satellite pictures. Typically, for electronic maps to be provided through the Internet, map information is hierarchically organized according to scale for storage in an electronic map database. For example, map information may be organized such that a higher level of map information with higher scales is hierarchically linked to a lower level of map information with lower scales. Such organization of map information allows a suitable level of map information to be provided and displayed on a user's terminal in response to the user's requests.

Advertisers may provide their advertisements to consumers with location information by registering and displaying advertisements on a predetermined location of an electronic map provided through the Internet. The advertisement content, which is displayed on the predetermined location of the electronic map, may include, for example, text advertisements of building/firm names, images or symbol advertisements, animation advertisements such as an animation GIF or Flash, voice advertisements, moving picture advertisements, and URL information that allows consumers to navigate to a website.

When advertisers register advertisements on an electronic map, they often wish to register advertisements at the location where the advertisements can be effectively displayed to users. Conventional advertising registration systems allow only a geographical view to be displayed to the advertisers. For example, when advertisers register advertisements on an electronic map, only the electronic map itself may be represented to the advertisers. Thus, the advertisers have no information about areas or business establishments frequently searched by users and thus have difficulty in deciding which areas are appropriate for registering their advertisements. As a result, the advertisers hesitate to register their advertisements.

### SUMMARY OF THE INVENTION

Various embodiments of the present invention provide methods and apparatus for displaying advertisement registration reference information such as, for example, business establishment information, geographical features information, and demographic information on an electronic map. By referring to the displayed advertisement registration reference information, advertisers can register their advertisements at the location(s) where the advertisements can be effectively delivered to the users.

According to a particular class of embodiments, methods and apparatus are provided for registering advertisements at an advertisement registration server for display on an electronic map. The advertisement registration server receives an access request from a terminal via a communication network. The server then retrieves predetermined map information and transmits the retrieved map information to the terminal in response to the receipt of the access request. The predetermined map information is associated with center coordinates and a scale value, and is structured into a lattice having a plurality of lattice units. The advertisement registration server retrieves advertisement registration reference information and transmits the retrieved advertisement registration reference information to the terminal. From the terminal, the advertisement registration server receives an advertisement registration request including advertisement information identifying one or more of the lattice units. The advertisement registration server registers the advertisement information in association with one or more lattice units identified in the registration request.

In accordance with an embodiment of the present invention, the advertisement information includes information associated with one of the lattice units and advertisement content.

In accordance with an embodiment of the present invention, retrieving the advertisement registration reference information comprises retrieving business establishment information and transmitting the retrieved business establishment information to the terminal.

In accordance with an embodiment of the present invention, retrieving the business establishment information comprises retrieving business establishment information related to business establishments, the coordinates of which are within a predetermined range from the center coordinates and have a number of click-throughs greater than a predetermined value. The business establishment information includes the name and coordinates of each business establishment as well as the number of click-throughs for each of the business establishments.

In accordance with an embodiment of the present invention, the number of click-throughs for each of the business establishments is updated in real-time by search engines.

In accordance with an embodiment of the present invention, retrieving the advertisement registration reference information comprises retrieving geographical features information and transmitting the retrieved geographical features information to the terminal.

In accordance with an embodiment of the present invention, retrieving the geographical features information comprises retrieving geographical features information related to geographical features, the coordinates of which are within a predetermined range from the center coordinates and have the number of click-throughs greater than a predetermined value. The geographical features information includes the name and coordinates of each geographical feature as well as the number of click-throughs for each of the geographical features.

In accordance with an embodiment of the present invention, retrieving the advertisement registration reference information comprises retrieving demographic information and transmitting the retrieved demographic information to the terminal.

In accordance with an embodiment of the present invention, retrieving the demographic information comprises retrieving demographic information regarding administrative districts, the coordinates of which are within a predetermined range from the center coordinates. The demographic information includes the population, average income and average age for each of the administrative districts.

In accordance with an embodiment of the present invention, the terminal may be a computer, a mobile communication terminal, an internet set top box or a PDA.

In accordance with an embodiment of the present invention, the advertisement content may include text, a symbol, an image, a moving picture, animation or a URL.

In accordance with another class of embodiments, methods and apparatus are provided for implementing registration of advertisements at an advertiser's terminal for display on an electronic map. The advertiser's terminal accesses an advertisement registration server. The advertiser's terminal then receives predetermined map information from the advertisement registration server. The predetermined map information is associated with center coordinates and a scale value, and is structured into a lattice having a plurality of lattice units. The advertiser's terminal displays an electronic map based on the predetermined map information. Then, the advertiser's terminal receives advertisement registration reference information from the advertisement registration server and displays the advertisement registration reference information on the electronic map. Finally, the advertiser's terminal receives an input selecting one or more of the lattice units and transmits location information about the one or more of the lattice units and advertisement content to the advertisement registration server.

In accordance with another class of embodiments, methods and apparatus are provided for displaying advertisements on an electronic map at a user's terminal. The user's terminal accesses an advertisement registration server and receives predetermined map information from the advertisement registration server. The predetermined map information is associated with center coordinates and a scale value, and is structured into a lattice having a plurality of lattice units. Then, the user's terminal displays an electronic map based on the predetermined map information. Finally, the user's terminal receives advertisement information including advertisements from the advertisement registration server and displays the advertisements on the electronic map. Each of the advertisements is associated with one or more of the lattice units.

A further understanding of the nature and advantages of the present invention may be realized by reference to the remaining portions of the specification and the drawings.

### BRIEF DESCRIPTION OF THE DRAWINGS

FIG. 1 illustrates an advertising registration system in accordance with an embodiment of the present invention.

FIG. 2 shows the configuration of a business establishment database in accordance with an embodiment of the present invention.

FIG. 3 shows a flow chart for registering advertisements in accordance with an embodiment of the present invention.

FIG. 4 shows a flow chart for illustrating the process of transmitting the map information and the advertisement registration reference information to the advertiser's terminal.

FIG. 5 shows a flow chart illustrating the process of providing the advertiser's terminal with business establishment information.

FIG. 6 shows the configuration of information from the business establishment database restructured based on the number of click-throughs.

FIG. 7 shows a flow chart illustrating the process of providing the advertiser's terminal with geographical features information.

FIG. 8 shows a flow chart illustrating the process of providing the advertiser's terminal with demographic information.

FIG. 9 shows a flow chart illustrating the process of receiving information from the advertisement registration server and processing the information.

FIG. 10 shows a page on which an electronic map along with business establishment information is displayed in accordance with an embodiment of the present invention.

FIG. 11 shows a page on which an electronic map along with geographical features information is displayed in accordance with an embodiment of the present invention.

FIG. 12 shows a page on which an electronic map along with demographic information is displayed in accordance with an embodiment of the present invention.

FIG. 13 shows a flow chart for displaying an electronic map with advertisements on a user's terminal in accordance with an embodiment of the present invention.

FIG. 14 illustrates an electronic map together with a plurality of advertisements displayed on the user's terminal in accordance with an embodiment of the present invention.

FIG. 15 is a simplified diagram of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

According to various embodiments of the present invention, advertisement registration reference information such as business establishment information, geographical features information, and demographic information is displayed on an electronic map. The advertisement registration reference information is retrieved from a reference information database such as, for example, a business establishment database, a geographical features database, and a demographic database. By referring to the advertisement registration reference information, advertisers can register their advertisements at the location where the advertisements can be effectively delivered to the users. In addition, the administrator of the advertisement registration system can make a profit by providing incentives for advertisers to register their advertisements.

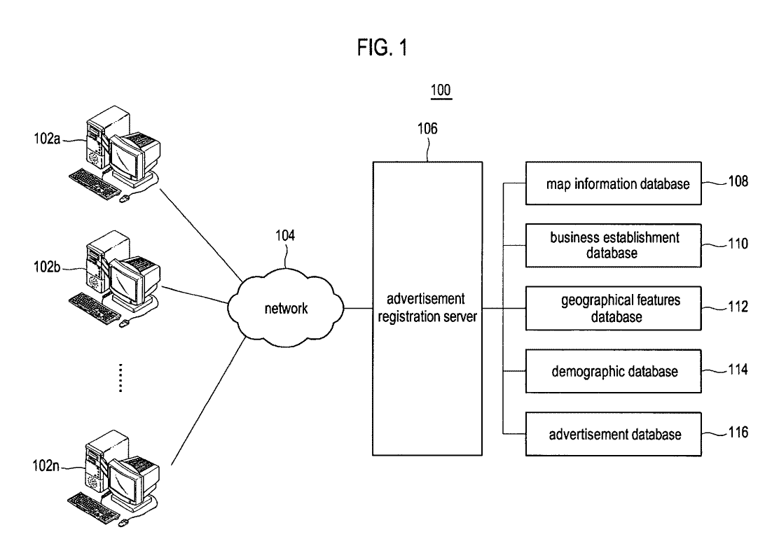

FIG. 1 illustrates one example of an advertising registration system implemented in accordance with an embodiment of the present invention. Referring to FIG. 1, an advertising registration system 100 includes a plurality of terminals 102a-102n. The plurality of terminals 102a-102n manipulated by advertisers may include, for example, computers, mobile communication terminals, Internet set top boxes, PDAs, etc. The plurality of terminals 102a-102n may include input devices such as mice, electronic pens, keyboards, joysticks, touch-screens, etc. to receive input from the advertisers. According to an embodiment of the present invention, the plurality of terminals 102a-102n may be operable to download applications such as web browsers, plug-in programs, applets, map applications, etc. from an advertisement registration server 106. Such applications may also be embedded in the plurality of terminals 102a-102n. As shown in FIG. 1, the plurality of terminals 102a-102n are connected to the advertisement registration server 106 via a network 104. The plurality of terminals 102a-102n are operable to receive information from the advertisement registration server 106. Some of the information may be processed by the map applications embedded in the terminals 102a-102n to be displayed on the monitors of the terminals 102a-102n. The network 104 may be, for example, the Internet or another similar wide area network which is provided by one or more telecommunications companies and allows the plurality of terminals 102a-102n to access the advertisement registration server 106 over a wide geographical area.

The advertisement registration server 106 receives an access request from one of the plurality of terminals 102a-102n via the network 104. In response to the access request, the advertisement registration server 106 transmits map information and advertisement registration reference information to the terminal. The advertisement registration reference information may include at least one of business establishment information, geographical features information, and demographic information. In this example, the advertisement registration server 106 is connected to a map information database 108, a business establishment database 110, a geographical features database 112, and a demographic database 114. The advertisement registration server 106 is operable to retrieve map information from the map information database 108 and transmit the retrieved map information to the terminal via the network 104. The advertisement registration server 106 is also operable to retrieve the advertisement registration reference information from one or more of the business establishment database 110, the geographical features database 112, or the demographic database 114. Although the map information database 108, the business establishment database 110, the geographical features database 112 and the demographic database 114 are illustrated as separate databases, it will be apparent to those skilled in the art that those databases may be implemented as either a fewer or larger number of databases. It then transmits the retrieved advertisement registration reference information to the terminal via the network 104. Further, when receiving an advertisement registration request from the terminal, the advertisement registration server 106 stores the information included in the advertisement registration request in an advertisement database 116.

The map information database 108 stores map information regarding various scale-levels of electronic maps. According to an embodiment of the present invention, the map information stored in the map information database 108 may be categorized into a total of 16 levels of scale value. According to another embodiment of the present invention, the map information may be categorized into more than or less than 16 levels of scale value. The map information stored in the map information database 108 may be identified by center coordinates and scale value of an electronic map. According to an embodiment of the present invention, the map information stored in the map information database 108 is structured into a plurality of lattice units partitioned with multiple equally-spaced column and row lines. The plurality of lattice units may or may not be equal-sized. According to an embodiment of the present invention, the size of the lattice units may vary depending on the various scale-levels of electronic maps stored in the map information database 108.

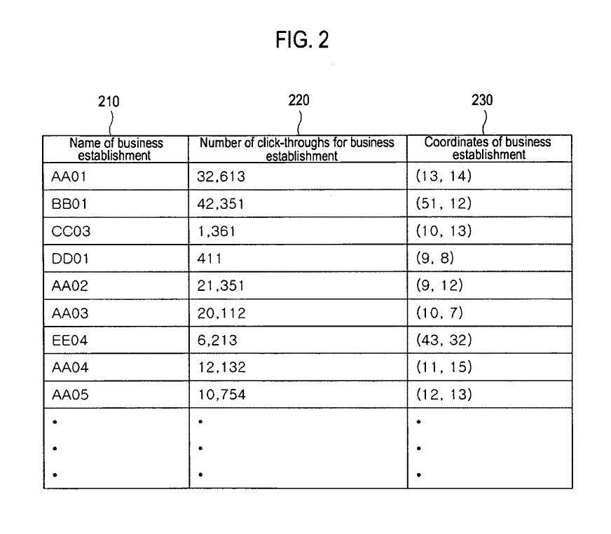

The business establishment database 110 stores business establishment names, the number of click-throughs for the business establishments, and the coordinates of the business establishments on the electronic map. A business establishment may include, for example, restaurants, hospitals, schools, retailers, etc. The click-through for a particular business establishment may involve, for example, the user's act of clicking on a hyperlink included in some of the plural search result items that a search engine, such as the Yahoo search engine, found as being relevant to the keyword entered by the user to access the website of the corresponding business establishment or to obtain information thereon. The number of click-throughs for each of the business establishments may be provided, for example, based at least in part on statistics data as stored in the Yahoo search engine. FIG. 2 shows an example of the configuration of a business establishment database 110 in accordance with an embodiment of the present invention. As shown in FIG. 2, the business establishment database 110 may include the fields of a name of the business establishment 210, the number of click-throughs for the business establishment 220, and the coordinates of the business establishment on the electronic map 230. The name of the business establishment 210 may include a corporate name, a firm name, etc. The number of click-throughs for the business establishment 220 represents the number of times that users search for the business establishment through search engines. The number of click-throughs for the business establishment 220 may be updated in real-time whenever users search for the business establishment. The coordinates 230 represent the location at which the business establishment is located.

Referring back to FIG. 1, the geographical features database 112 stores information about geographical features displayed on the electronic map. According to an embodiment of the present invention, the geographical features database 112, similar to the business establishment database 110, may include the fields of the name of the geographical features, the number of click-throughs for the geographical features, and the coordinates of the geographical features on the electronic map. The demographic database 114 stores the demographic information for administrative districts associated with or included within the electronic map. The administrative district may include, for example, a state, a county, a city, a town or a village. According to an embodiment of the present invention, the demographic database 114 may include the fields of a population, an average age, and an average income for each of the administrative districts. The advertisement database 116 stores advertisement content or information as to where the content can be found (e.g., link information) in association with location information about the lattice units on which the advertisement content is to be displayed.

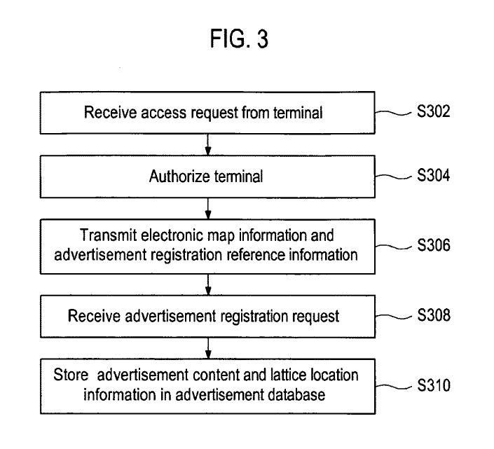

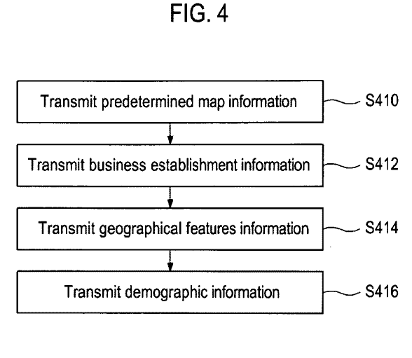

FIG. 3 shows a flow chart for registering advertisements in accordance with an embodiment of the present invention. The advertisement registration server 106 receives an access request from one of the advertisers' terminals 102a-102n at the step 302. The advertisement registration server 106 performs predefined authorization of the access request at the step 304. After authorization, the advertisement registration server 106 transmits the map information and the advertisement registration reference information such as business establishment information, geographical features information, and demographic information to the advertiser's terminal at the step 306. The process of transmitting the map information and the advertisement registration reference information will be explained with reference to FIGS. 4 to 8. After transmitting the map information and the advertisement registration reference information to the advertiser's terminal, the advertisement registration server 106 receives the advertisement registration request from the advertiser's terminal at the step 308. According to an embodiment of the present invention, the advertisement registration request may include location information about the lattice unit in which the advertiser registers its advertisement and the advertisement content to be displayed on the lattice unit (e.g., text, image or symbol, animation GIF, Flash, etc.). At the step 310, the advertisement registration server 106 stores the location information about the lattice unit and the advertisement content in the advertisement database 116.

FIG. 4 shows a flow chart for illustrating the process of transmitting the map information and the advertisement registration reference information to the advertiser's terminal. At the step 410, the advertisement registration server 106 transmits predetermined map information to the advertiser's terminal. According to an embodiment of the present invention, the advertisement registration server 106 may retrieve world map information from the map information database 108 and transmit the retrieved world map information to the advertiser's terminal. According to another embodiment of the present invention, the advertisement registration server 106 may retrieve map information relating to a nation or region in which the advertiser accessing the advertisement registration server 106 is located from the map information database 108 and transmit the retrieved map information to the advertiser's terminal. For example, if the advertiser is located in Seoul, Korea, then map information relating to Seoul or Korea may be transmitted to the advertiser's terminal. According to another embodiment of the present invention, map information about a certain area pre-stored by an advertiser may be transmitted to the advertiser's terminal.

At the steps 412, 414, and 416, the advertisement registration server 106 retrieves the business establishment information, the geographical features information, and the demographic information from the business establishment database 110, the geographical features database 112, and the demographic information database 114, respectively. It then transmits the retrieved information to the advertiser's terminal. According to various embodiments of the present invention, the business establishment information, the geographical features information, and the demographic information may be transmitted to the advertiser's terminal simultaneously or in any order. According to another embodiment of the present invention, only some of the business establishment information, the geographical features information, and the demographic information is transmitted to the advertiser's terminal.

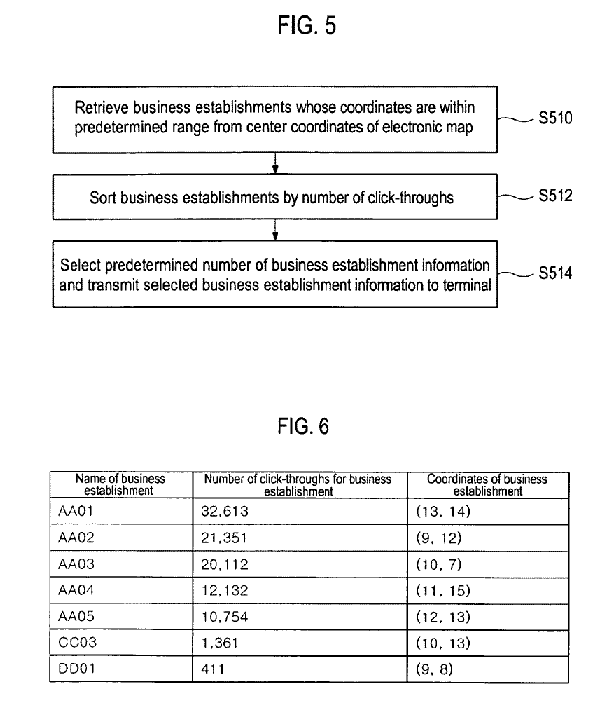

FIG. 5 shows a flow chart illustrating the process of providing the advertiser's terminal with business establishment information. At the step 510, the advertisement registration server 106 retrieves information about business establishments from business establishment database 110, the coordinates of which are within the predetermined range from center coordinates of the electronic map that has been transmitted to the advertiser's terminal at the step 410 of FIG. 4. According to an embodiment of the present invention, the predetermined range may refer to an area within a certain distance from center coordinates of the electronic map being displayed on the advertiser's terminal. For the example of FIG. 2, if the predetermined range is defined as a range of ±5 from coordinates (10, 10), then the business establishment information of business establishments AA01, CC03, DD01, AA02, AA03, AA04, and AA05, but not of BB01 and EE04, will be obtained.

At the step 512, the advertisement registration server 106 sorts the retrieved business establishments by the number of click-throughs for the business establishments. According to an embodiment of the present invention, the advertisement registration server 106 may restructure the information obtained from business establishment database 110 so that the retrieved business establishments are aligned based on the number of click-throughs. As an example, FIG. 6 shows that the information from business establishment database 110 is restructured so that the business establishments AA01, CC03, DD01, AA02, AA03, AA04, and AA05 retrieved at the step 510 are aligned based on their number of click-throughs. The advertisement registration server 106 selects a predetermined number of the business establishment information having a relatively high number of click-throughs and transmits the selected business establishment information to the advertiser's terminal at the step 514. According to an embodiment of the present invention, the business establishment information regarding the predetermined number (e.g., five) of business establishments which are ranked high in the restructured database (e.g., AA01 to AA05), are transmitted to the advertiser's terminal. The number of business establishment information transmitted is not limited to five and may be less than or more than five. According to another embodiment of the present invention, all of the business establishment information, the number of click-throughs of which is not less than a predetermined threshold, may be transmitted to the advertiser's terminal.

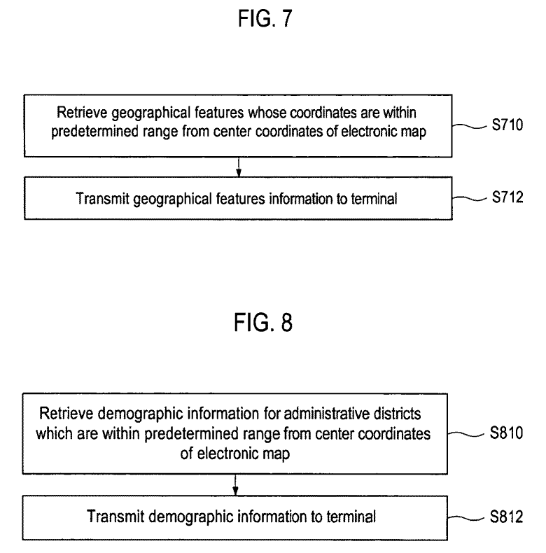

FIG. 7 shows a flow chart illustrating the process of providing the advertiser's terminal with geographical features information. At the step 710, the advertisement registration server 106 retrieves information about geographical features, the coordinates of which are within a predetermined range from center coordinates of the electronic map that has been transmitted to the advertiser's terminal at the step 410 of FIG. 4. According to an embodiment of the present invention, the geographical features may include, for example, roads, rivers, seas, mountains, etc. Further, the information about the geographical features may include the names of the geographical features, the number of click-throughs for the geographical features, and the coordinates of the geographical features on the electronic map. According to an embodiment of the present invention, the step of retrieving the geographical features information may be implemented in a manner similar to the retrieving of the business establishment information as explained with reference to FIG. 5. However, it should be noted that the predetermined range within which the coordinates of geographical features are included may be the same or different from the range used for retrieving the business establishment information. The advertisement registration server 106 transmits the retrieved geographical features information to the advertiser's terminal at the step 712.

FIG. 8 shows a flow chart illustrating the process of providing the advertiser's terminal with demographic information. At the step 810, the advertisement registration server 106 retrieves demographic information for administrative districts, the coordinates of which are within a predetermined range from center coordinates of the electronic map that has been transmitted to the advertiser's terminal at the step 410 of FIG. 4. According to an embodiment of the present invention, the demographic information for every administrative district may be stored in the demographic information database 114. Again, it should be noted that the predetermined range within which all or a portion of such administrative districts are included may be the same or different from the range used for retrieving the business establishment information or the geographic features information. The advertisement registration server 106 transmits the retrieved demographic information to the advertiser's terminal at the step 812.

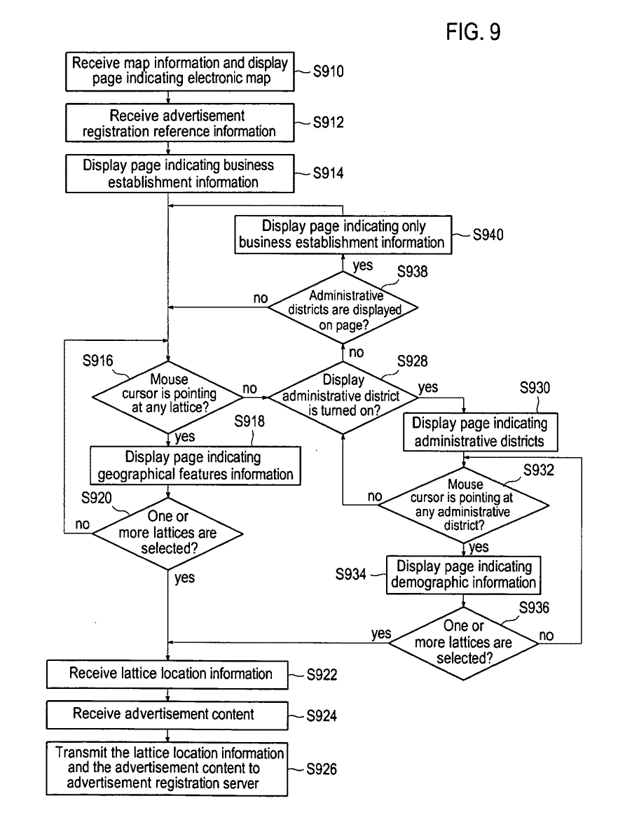

FIG. 9 shows a flow chart illustrating the process of receiving information from the advertisement registration server and processing the information. At the step 910, the advertiser's terminal receives map information from the advertisement registration server 106 and displays map information on its monitor by using the map application. Then, the advertiser's terminal receives advertisement registration reference information from the advertisement registration server 106 at the step 912. As discussed above, the advertisement registration reference information may include business establishment information, geographical features information, and demographic information. According to various embodiments of the present invention, the business establishment information, the geographical features information, and the demographic information may be received simultaneously or in any order. According to another embodiment of the present invention, only some of the business establishment information, the geographical features information, and the demographic information may be received. At the step 914, the advertiser's terminal displays a page indicating the business establishment information on the electronic map.

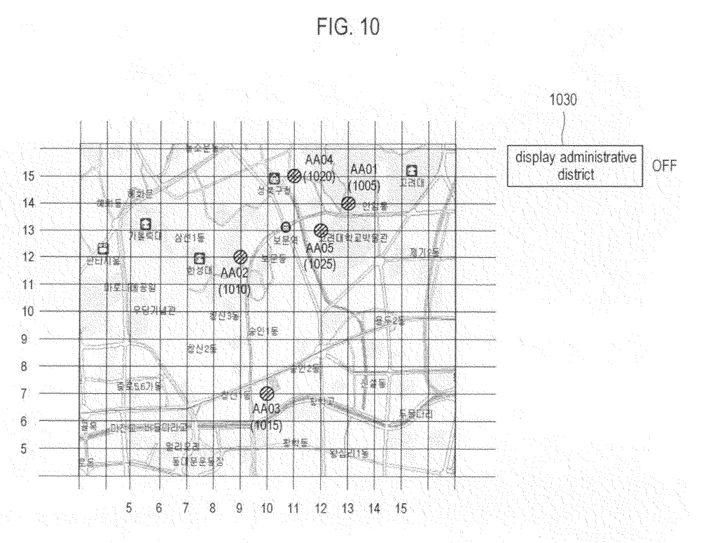

FIG. 10 shows an example of a page on which an electronic map along with business establishment information is displayed in accordance with an embodiment of the present invention. As shown in FIG. 10, the electronic map is structured into a plurality of lattice units defined in the figure by row and column lines. A “display administrative district button” 1030 is displayed on the right side of the electronic map. The names of business establishments 1005, 1010, 1015, 1020, and 1025 are displayed at the corresponding coordinates on the electronic map. For example, the business establishment name AA02 1102 is displayed at coordinates (9, 12). Using this view, advertisers can understand the locations of the business establishments that users frequently search for through search engines while browsing the region in which advertisers intend to register their advertisements. Thus, the advertisers are able to register their advertisements at suitable locations so that the advertisements can be effectively delivered to the users. As an example, if the advertiser understands the location of AA04 shopping mall 1020 that users frequently search for, then the advertiser will intend to register advertisements on its clothes near the AA04 shopping mall 1020. As such, the administrator of the advertisement registration system can create and communicate incentives for the advertisers to register advertisements.

After the business establishment information is displayed on the electronic map, it is checked whether a mouse cursor (or an equivalent pointing or selection mechanism) on the display of the advertiser's terminal is pointing at any lattice unit of the electronic map at the step 916. If it is determined that the mouse cursor is pointing at a particular lattice unit, then a page indicating the geographical features information relating to that lattice unit is displayed at the step 918.

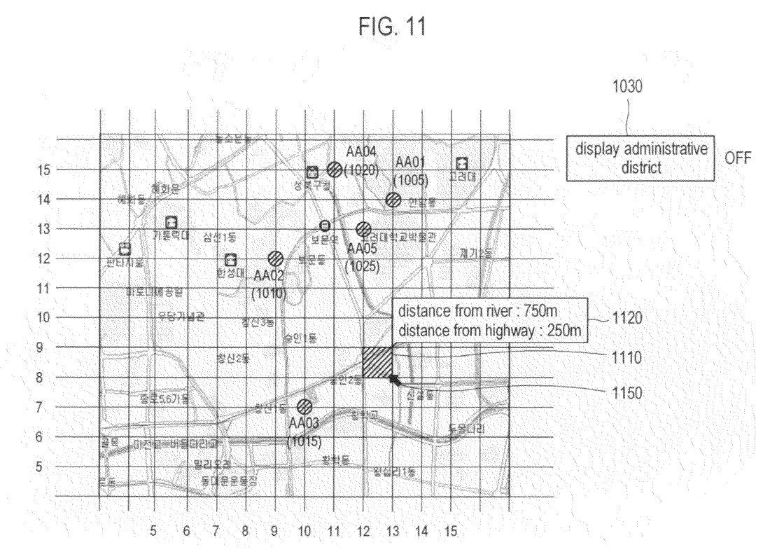

FIG. 11 shows an example of a page on which an electronic map along with geographical features information is displayed in accordance with one embodiment of the present invention. The names of the business establishments 1005, 1010, 1015, 1020, and 1025 are still displayed on the electronic map of FIG. 11. According to an embodiment of the present invention, if the advertiser places the mouse cursor 1150 to point at a lattice unit 1110 by using an input device, then a tooltip 1120 is displayed on the electronic map which represents the distances from adjacent geographical features including a river and a highway to the center of the lattice unit. Since the distances from geographical features to a certain lattice unit are displayed on the electronic map, advertisers can effectively determine whether it is appropriate to register their advertisements in the lattice unit.

Referring back to FIG. 9, after the geographical features information is displayed on the electronic map at the step 918, it is checked whether one or more lattice units of the electronic map are selected at the step 920. If it is determined that no lattice unit is selected, then the process returns to the step 916. If it is determined that one or more lattice units are selected, then the advertiser's terminal receives location information about one or more lattice units at the step 922. The advertiser's terminal receives advertisement content entered or selected by the advertiser at the step 924. At the step 926, the advertiser's terminal transmits the received lattice unit location information and the advertisement content to the advertisement registration server 106. As such, the process of registering an advertisement in the lattice units is completed.

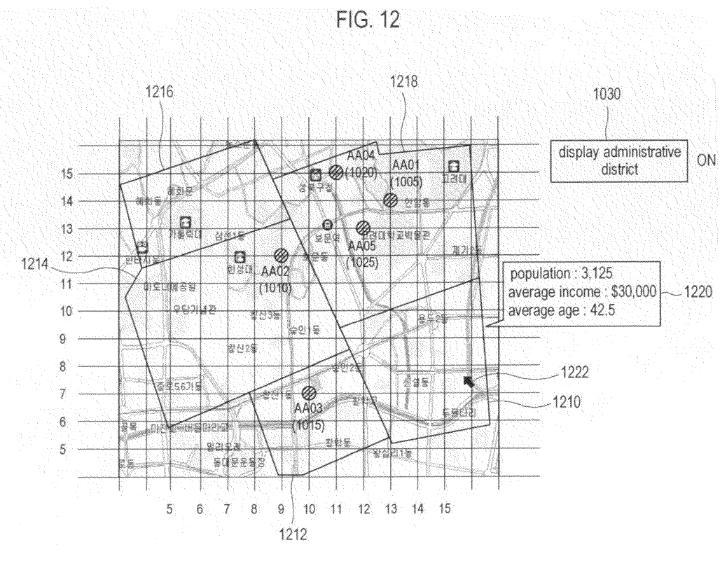

According to a specific embodiment of the invention, if it is determined that the mouse cursor is not pointing at any lattice unit at the step 916, then it is checked whether the administrative district display is turned on at the step 928. According to this embodiment of the present invention, the administrative district display is basically turned off as shown in FIG. 10. However, if the advertiser clicks the “display administrative district” button 1030 in FIG. 10, then the administrative district display may change from an off-state to an on-state. In the on-state, if the advertiser clicks the “display administrative district” button 1030, then the “display administrative district” may change from the on-state to the off-state. If it is determined that the “display administrative district” is turned on at the 928, then the advertiser's terminal displays a page indicating a plurality of administrative districts on the electronic map at the step 930. FIG. 12 shows an example of an electronic map on which administrative districts are displayed. According to an embodiment of the present invention, a plurality of administrative districts 1210, 1212, 1214, 1216, and 1218 may be displayed on the electronic map as shown.

After the administrative districts are displayed on the electronic map at the step 930, it is checked whether the mouse cursor is pointing at any administrative district on the electronic map at the step 932. If it is determined that the mouse cursor is not pointing at any administrative district, then the process returns to the step 928 and there are no changes on the display. On the other hand, if it is determined that the mouse cursor is pointing at a particular administrative district, then a page indicating demographic information relating to the corresponding administrative district is displayed at the step 934. According to an embodiment of the present invention, the demographic information relating to the administrative district may include a population, an average income, and an average age of the administrative district. As an example, if the advertiser places the mouse cursor 1222 to point at the administrative district 1210 by using an input device, then a tooltip 1220 is displayed on the electronic map 1200 which represents the population, the average income, and the average age of the administrative district.

After the demographic information is displayed on the electronic map at the step 934, it is checked whether any lattice unit on the electronic map is selected at the step 936. If it is determined that no lattice unit is selected, then the process returns to the step 932. If it is determined that a certain lattice unit is selected, then the process proceeds to the step 922. The advertiser's terminal receives the location information about the lattice unit and advertisement content from the advertiser at the steps 922 and 924. It then transmits the received lattice unit location information and the advertisement content to the advertisement registration server 106 at the step 926. As such, the process of registering an advertisement in the lattice units is completed.

If it is determined that the “display administrative district” is turned off at the 928, then it is checked whether the administrative districts are displayed on the electronic map at the step 938. If it is determined that no administrative district is displayed on the electronic map, then the process returns to the step 916. If it is determined that the administrative districts are displayed on the electronic map, then the advertiser's terminal displays a page indicating only the business establishment information on the electronic map at the step 940. That is, the display of the administrative districts disappears from the electronic map. Then, the process returns to the step 916.

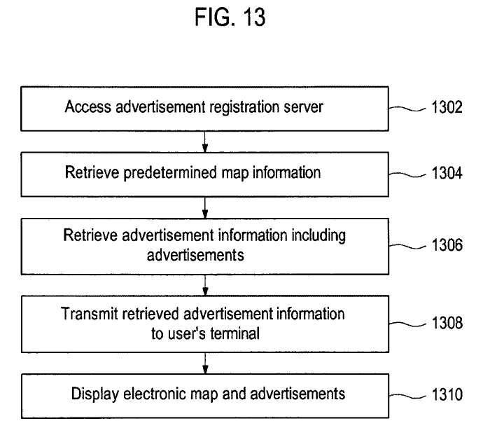

FIG. 13 shows a flow chart for displaying an electronic map with advertisements on a user's terminal in accordance with an embodiment of the present invention. The user's terminal accesses the advertisement registration server 106 via the network 104 at the step 1302. Upon being accessed by the user's terminal, the advertisement registration server 106 retrieves predetermined map information from the map information database 108 and transmits the retrieved map information to the user's terminal via the network at the step 1304. The advertisement registration server 106 then retrieves advertisement information including advertisements located within the predetermined distance from the center coordinates of the retrieved map information from the advertisement database 116 at the step 1306. The advertisement registration server 106 transmits the retrieved advertisement information to the corresponding user's terminal via the network 104 at the step 1308. The user's terminal displays an electronic map and a plurality of advertisements on the appropriate location thereof by transforming the transmitted map information and advertisement information into suitable forms at the step 1310.

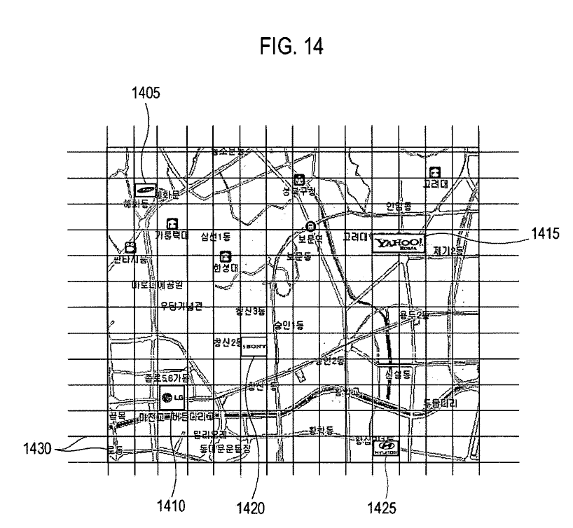

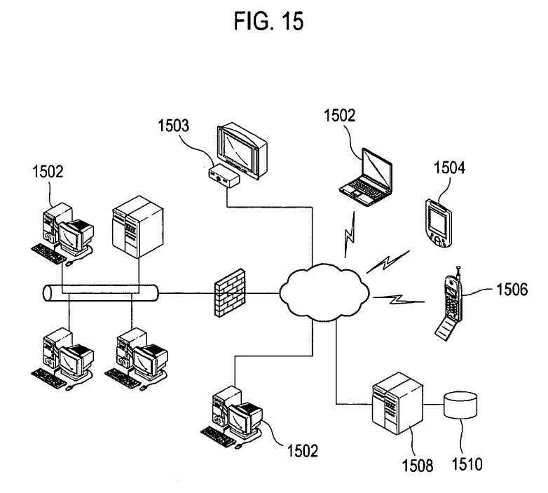

FIG. 14 illustrates an electronic map together with a plurality of advertisements displayed on the user's terminal in accordance with an embodiment of the present invention. As shown in FIG. 14, the electronic map includes a plurality of lattice units partitioned with a plurality of equally-spaced column and row lines 1430. Although the column and row lines 1430 are shown for illustrative purposes, it should be noted that they may not be displayed on the user's terminal according to an embodiment of the invention. A total of five advertisements 1405, 1410, 1415, 1420, and 1425 are displayed on the electronic map. According to an embodiment of the present invention, each of the advertisements may be one of the following: a text, symbol, image, moving picture, animation, URL or any combination thereof. As shown in FIG. 14, each of the advertisements 1405, 1410, 1415, 1420, and 1425 is displayed within the corresponding lattice unit area that was purchased in the course of registering advertisement content as discussed in conjunction with FIG. 9. The corresponding lattice unit area may include one or more lattice units. In the embodiment shown, each of the advertisements 1405, 1410, 1420, and 1425 is displayed within one lattice unit, while the advertisement content 1415 is displayed within two lattice units.

Embodiments of the present invention may be employed to enable advertisers to register advertisements for display on electronic maps in any of a wide variety of computing contexts. For example, as illustrated in FIG. 15, implementations are contemplated in which the relevant population of users (e.g., including both advertiser representatives as well as consumers) interacts with a diverse network environment via any type of computer (e.g., desktop, laptop, tablet, etc.) 1502, media computing platforms 1503 (e.g., cable and satellite set top boxes and digital video recorders), handheld computing devices (e.g., PDAs, email clients, etc.) 1504, cell phones 1506 or any other type of computing or communication platform.

As will be understood, the various processes and services enabled by embodiments of the invention may be provided in a centralized manner. This is represented in FIG. 15 by server 1508 and data store 1510 which, as will be understood, may correspond to multiple distributed devices and data stores. The various services enabled by the present invention may then be provided to users in the network via the various channels with which the users interact with the network.

The various aspects of the invention may also be practiced in a wide variety of network environments (represented by network 1512) including, for example, TCP/IP-based networks, telecommunications networks, wireless networks, etc. In addition, the computer program instructions and data structures with which embodiments of the invention are implemented may be stored in any type of computer-readable media, and may be executed according to a variety of computing models including, for example, a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method of registering advertisements at an advertisement registration server for display on an electronic map, comprising:
receiving an access request from a terminal via a communication network;
retrieving predetermined map information and transmitting the retrieved map information to the terminal in response to the receipt of the access request, said predetermined map information being associated with center coordinates and a scale value and structured into a lattice having a plurality of lattice units;
retrieving advertisement registration reference information and transmitting the retrieved advertisement registration reference information to the terminal;
receiving an advertisement registration request from the terminal, said advertisement registration request including advertisement information identifying one or more of the plurality of lattice units; and
registering the advertisement information in association with the one or more lattice units identified in the registration request.

2. The method of claim 1, wherein the advertisement information includes information associated with the one or more of the lattice units and advertisement content or link information for the advertisement content.

3. The method of claim 1, wherein retrieving the advertisement registration reference information comprises:
retrieving business establishment information and transmitting the retrieved business establishment information to the terminal.

4. The method of claim 3, wherein retrieving the business establishment information comprises:
retrieving business establishment information related to business establishments whose coordinates are within a predetermined range from the center coordinates and have a number of click-throughs greater than a predetermined value, said business establishment information including a name and coordinates of each of the business establishments and the number of click-throughs for each of the business establishments.

5. The method of claim 4, wherein the number of click-throughs for each of the business establishments is updated in real-time by search engines.

6. The method of claim 1, wherein retrieving the advertisement registration reference information comprises:
retrieving geographical features information and transmitting the retrieved geographical features information to the terminal.

7. The method of claim 6, wherein retrieving the geographical features information comprises:
retrieving geographical features information related to geographical features whose coordinates are within a predetermined range from the center coordinates and have a number of click-throughs greater than a predetermined value, said geographical features information including a name and coordinates of each of the geographical features and the number of click-throughs for each of the geographical features.

8. The method of claim 1, wherein retrieving the advertisement registration reference information comprises:
retrieving demographic information and transmitting the retrieved demographic information to the terminal.

9. The method of claim 8, wherein retrieving the demographic information comprises:
retrieving demographic information about administrative districts whose coordinates are within a predetermined range from the center coordinates, said demographic information including a population, an average income, and an average age for each of the administrative districts.

10. The method of claim 1, wherein the terminal is any one of a computer, mobile communication terminal, internet set top box, or a PDA.

11. The method of claim 2, wherein the advertisement content includes one or more of text, a symbol, an image, a moving picture, an animation, or a URL.

12. An apparatus, comprising:
one or more network interfaces;
one or more processors; and
a data storage medium storing computer-readable instructions operative to cause the one or more processors to:
receive an access request from a terminal via a communication network;
retrieve predetermined map information and transmit the retrieved map information to the terminal in response to receiving the access request, said predetermined map information being associated with center coordinates and a scale value and structured into a lattice having a plurality of lattice units;
retrieve advertisement registration reference information and transmit the retrieved advertisement registration reference information to the terminal;
receive an advertisement registration request from the terminal, said advertisement registration request including advertisement information identifying one or more of the plurality of lattice units; and
register the advertisement information in association with one or more lattice units identified in the registration request.

13. An apparatus of claim 12, wherein the advertisement information includes information associated with one or more of the lattice units and advertisement content or link information for the advertisement content.

14. An apparatus of claim 13, wherein the advertisement content includes one or more of a text, a symbol, an image, a moving picture, an animation, or a URL.

15. A method of implementing a registration of advertisements at an advertiser's terminal for display on an electronic map, comprising:
accessing an advertisement registration server;
receiving predetermined map information from the advertisement registration server, said predetermined map information being associated with center coordinates and a scale value and structured into a lattice having a plurality of lattice units;
displaying an electronic map based on the predetermined map information;
receiving advertisement registration reference information from the advertisement registration server;
displaying the advertisement registration reference information on the electronic map;
receiving an input selecting one or more of the lattice units; and
transmitting location information about the one or more of the lattice units and advertisement content to the advertisement registration server.

16. The method of claim 15, wherein displaying the advertisement registration reference information on the electronic map comprises:
displaying one or more of business establishment information, geographical features information, or demographic information on the electronic map.

17. A method of displaying advertisements on an electronic map at a user's terminal, comprising:
accessing an advertisement registration server;
receiving predetermined map information from the advertisement registration server, said predetermined map information being associated with center coordinates and a scale value and structured into a lattice having a plurality of lattice units;
displaying an electronic map based on the predetermined map information;
receiving advertisement information including advertisements from the advertisement registration server, each of said advertisements being associated with one or more of the lattice units; and
displaying the advertisements on the electronic map.

18. The method of claim 17, wherein each of the advertisements is located within a predetermined distance from the center coordinates.

19. The method of claim 17, wherein each of the advertisements is displayed within the one or more associated lattice units.

20. A method of registering advertisements at an advertisement registration server for display on an electronic map, comprising:
receiving an access request from a terminal via a communication network;
retrieving predetermined map information and advertisement registration reference information in response to the receipt of the access request, said predetermined map information being associated with center coordinates and a scale value and structured into a lattice having a plurality of lattice units;
transmitting the retrieved map information and the retrieved advertisement registration reference information to the terminal;
receiving an advertisement registration request from the terminal, said advertisement registration request including advertisement information identifying one or more of the plurality of lattice units; and
registering the advertisement information in association with the one or more lattice unit identified in the registration request.
